(19) United States
(12) Patent Application Publication
(10) Pub. No.: US 2005/0036502 A1
(43) Pub. Date: Feb. 17, 2005

(54) System and method for handling multicast traffic in a shared buffer switch core collapsing ingress VOQ's

(75) Inventors: Alain Blanc, Tourrettes sur Loop (FR); Rene Glaise, Nice (FR); Francois Le Maut, Nice (FR); Michel Poret, Valbonne (FR)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/895,159

(22) Filed: Jul. 20, 2004

(30) Foreign Application Priority Data
Jul. 23, 2003 (EP) 03368075.2

(51) Int. Cl. H04L 12/56; H04L 12/43

(52) U.S. Cl. 370/412; 370/395.1; 370/432; 370/390

(57) ABSTRACT

A system and a method to avoid packet traffic congestion in a shared memory switch core, while dramatically reducing the amount of shared memory in the switch core and the associated egress buffers and handling unicast as well as multicast traffic. According to the invention, the virtual output queuing (VOQ) of all ingress adapters of a packet switch fabric are collapsed into its central switch core to allow an efficient flow control. The transmission of data packets from an ingress buffer to the switch core is subject to a mechanism of request/acknowledgment. Therefore, a packet is transmitted from a virtual output queue to the memory shared switch core only if the switch core can send it to the corresponding egress buffer. A token based mechanism allows the switch core to determine the egress buffer's level of occupation. Therefore, since the switch core knows the states of the input and output adapters, it is able to optimize packet switching and to avoid packet congestion. Furthermore, since a packet is admitted in the switch core only if it can be transmitted to the corresponding egress buffer, the shared memory is reduced.

### CROSS REFERENCE TO RELATED PATENT APPLICATIONS

The following patent applications are related to the subject matter of the present application and are assigned to common assignee:

1. U.S. patent application Ser. No. ______ (docket FR920030044US1), Alain Blanc et al., “System and Method for Collapsing VOQ's of a Packet Switch Fabric”, filed concurrently herewith for the same inventive entity;

2. U.S. patent application Ser. No. ______ (docket FR920030045US1), Alain Blanc et al., “Algorithm and System for Selecting Acknowledgments from an Array of Collapsed VOQ's”, filed concurrently herewith for the same inventive entity.

The above applications are incorporated herein by reference.

### FIELD OF THE INVENTION

The present invention relates to high speed switching of data packets in general and, is more particularly concerned with a system and a method that permit to handle multicast traffic, concurrently with the unicast traffic, in a switch fabric that collapses all ingress port adapter virtual output queues (VOQ's) in its switching core while allowing an efficient flow control.

### BACKGROUND OF THE INVENTION

The explosive demand for bandwidth over all sorts of communications networks has driven the development of very high-speed switch fabric devices. Those devices have allowed the practical implementation of network nodes capable of handling aggregate data traffic in a large range of values i.e., with throughputs from a few gigabit (10⁹) to multi-terabit (10¹²) per second. To carry out switching at network nodes, today's preferred solution is to employ, irrespective of the higher communications protocols actually in use to link the end-users, fixed-size packet (or cell) switching devices. These devices, which are said to be protocol agnostic, are considered to be simpler and more easily tunable for performances than other solutions especially, those handling variable-length packets. Thus, N×N switch fabrics, which can be viewed as black boxes with N inputs and N outputs, have been made capable of moving short fixed-size packets (typically 64-byte packets) from any incoming link to any outgoing link. Hence, communications protocol packets and frames need to be segmented in fixed-size packets while being routed at a network node. Although short fixed-size packet switches are thus often preferred, the segmentation and subsequent necessary reassembly (SAR) they assume have a cost. Switch fabrics that handle variable-size packets are thus also available. They are designed so that they do not require or limit the amount of SAR needed to route higher protocol frames.

Whichever type of packet switch is considered they have however in common the need of an efficient flow control mechanism which must attempt to prevent all forms of congestion. To this end, all modern packet switches use a scheme referred to as ‘virtual output queuing’ or VOQ. As sketched in FIG. 1, all ingress port adapters or IA's (100) to a switch core (110) are temporarily storing incoming packets (105) in a ‘first come first served’ or FCFS order, generally in the form of linked list of packets (120) however, sorted on a per destination basis and more generally on a per flow basis (125). Depending on the type of application considered, flows can have to be differentiated not only by their destinations but also according to priorities or ‘class of service’ (CoS) and possibly according to other traffic characteristics such as of being a multicast (MC) flow of packets that must be replicated to be forwarded to multiple destinations as opposed to unicast (UC) flows. Hence, flows, are differentiated with flow-ID's which include destinations and possibly many more parameters especially, a CoS.

Organizing input queuing as a VOQ has the great advantage of preventing any form of ‘head of line’ or HoL blocking. HoL blocking is potentially encountered each time incoming traffic, on one input port, has a packet destined for a busy output port, and which cannot be admitted in the switch core, because flow control mechanism has determined it is better to do so e.g., to prevent an output queue (OQ) such as (130) from over filling. Hence, other packets waiting in line are also blocked since, even though they would be destined for an idle output port, they just cannot enter the switch core. To prevent this from ever occurring, IA's input queuing is organized as a VOQ (115). Incoming traffic on each input port i.e., in each IA, is sorted per port destination (125) and in general per class of service or flow-ID, so that if an output port is experiencing congestion, traffic for other ports, if any, can be selected instead thus, has not to wait in line.

This important scheme of switch fabrics which authorizes input queuing without its drawback i.e., HoL blocking, was first introduced by Y. Tamir and G. Frazier, “High performance multi-queue buffers for VLSI communication switches,” in Proc. 15th Annu. Symp. Comput. Arch., June 1988, pp. 343-354. It is universally used in all kinds of switch fabrics that rely on input-queuing and is described, or simply assumed, in numerous publications dealing with this subject. As an example, a description of the use of VOQ and of its advantages can be found in “The iSLIP Scheduling Algorithm for Input-Queued Switches” by Nick McKeown, IEEE/ACM TRANSACTIONS ON NETWORKING, VOL. 7, NO. 2, April 1999.

The implementation of a packet switching function brings a difficult challenge which is the overall control of all the flows of data entering and leaving it. Whichever method is adopted for flow control, this always assumes that packets can be temporarily held at various stages of the switching function so as to handle flows on a priority basis thus supporting QoS (Quality of Service) and preventing switch to get congested. VOQ scheme fits well with this, allowing packets to be preferably held in input queues i.e., in IA's (100), before entering the switch core (110) while not introducing any blocking of higher priority flows.

As an example of this, FIG. 1 shows a shared-memory (SM) switch core (112) equipped with port OQ's (135) whose filling is monitored so as incoming packets can be held in VOQ's to prevent output congestion to occur. To prevent OQ's from ever overflowing, packets are no longer admitted when an output congestion is detected. Congestion occurs because too much traffic, destined for one output port or a set of output ports, is entering the switch core. As an elementary example of this one may consider two input ports each receiving 75% of their full traffic destined for a same given output port. This latter can only drain 100% of the corresponding traffic (ports IN and OUT typically, have identical speed) thus, the traffic in excess (50%) must be stored in the shared-memory and starts to build-up. If congestion lasts, and if nothing is done, the shared-memory fills up and the related OQ (130) soon overflows. Therefore, all OQ's are watched so as, if they tend to fill up, a feedback mechanism (140) prevents packets for a congested switch core output from leaving the corresponding VOQ's of IA's. This is easily achieved since VOQ's, in each ingress IA, are organized per destination as discussed above. Obviously, this is done on a priority basis i.e., lower priority packets are held first (although, for a sake of clarity, this is not shown in FIG. 1, VOQ's are organized per priority too) according to a series of thresholds (145) associated to the set of OQ's (135).

This scheme works well as long as the time to feed the information back to the source of traffic i.e., the VOQ's of IA's (100), is short when expressed in packet-times. However, packet-time reduces dramatically in the most recent implementation of switch fabrics where the demand for performance is such that aggregate throughput must be expressed in tera (10¹²) bits per second. As an example, packet-time can be as low as 8 ns (nanoseconds i.e.: 10⁻⁹ sec.) for 64-byte packets received on OC-768 or 40 Gbps (10⁹ bps) switch port having a 1.6 speedup factor thus, actually operating at 64 Gbps. As a consequence, round trip time (RTT) of the flow control information is far to be negligible as this used to be the case with lower speed ports. As an example of a worst case traffic scenario, all input ports of a 64-port switch may have to forward packets to the same output port eventually creating a hot spot. It will take RTT time to detect and block the incoming traffic in all VOQ's involved. If RTT is e.g.: 16 packet-times then, 64×16=1024 packets may have to accumulate for the same output in the switch core. A RTT of 16 packet-times corresponds to the case where, for practical considerations and mainly because of packaging constraints, distribution of power, reliability and maintainability of a large system, port adapters cannot be located in the same shelf and have to interface with the switch core ports through cables. Then, if cables (150) are 10 meter long, because light is traveling at 5 nanoseconds per meter, it takes 100 nanoseconds or about 12 packet-times (8 ns) to go twice through the cables. Then, adding the internal processing time of the electronic boards, including the multi-Gbps serializer/deserializer (SERDES), the this may easily add up to the 16 packet-times used in the above example.

Hence, when the performance of a large switching equipment approaches or crosses the 1 Tbps level, typically with 40 Gbps (OC-768) ports, RTT expressed in packet-time is becoming too high to continue to use a standard or backpressure flow control mechanism such as the ones briefly discussed in FIG. 1. Because this type of flow control assumes that all IA's, independently, keep forwarding traffic to the switch core, and relies on the feedback (140) of flow control information to stop sending if a congestion is detected clearly, the reaction time becomes too high. When a congestion is detected, by the time it is reported to the sources, the situation may have dramatically worsen up to a point where it is not longer containable forcing to discard packets especially, if for an extended period of time, the traffic is biased to a single or a few output ports (hot spot).

The above however refers primarily to the case of the unicast traffic. That is, when incoming packets need to be forwarded to only one destination or output port e.g., (155). It is as well important to be able to handle efficiently multicast traffic i.e., traffic that arrives from an ingress port and which must be dispatched on more than one output port in any combination of 2 to N ports.

Multicast traffic is becoming increasingly important with the development of networking applications such as video-distribution or video-conferencing. Multicast has traditionally been an issue in packet switches because of the intrinsic difficulty to handle all combinations of destinations without any restriction. As an example, with a 16-port fabric there are possibly 2¹⁶-17 combinations of multicast flows i.e., about 65 k flows. This number however reaches four billions of combinations with a 32-port switch (2³²-33). Even though it is never the case that all combinations need and can be used simultaneously there must be, ideally, no restrictions in the way multicast flows are allowed to be assigned to output port combinations for a particular application. As illustrated on FIG. 1, only one queue (MC) is generally dedicated for all multicast packets (per IA and per CoS) first, because it is in practice impossible to implement all combinations of multicast flows each with their own queue, and also because it does not really help to have only a limited number of MC queues due to the multiplicity of possible combinations.

Therefore, there is a need to be able to support MC traffic, from a single MC queue, part of a VOQ organized ingress adapter, to a switch core of a kind aimed at solving the problems raised by the back-pressure type of switch core of previous art thus, implementing a collapsed virtual output queuing mechanism or cVOQ and this without any design restriction on the way output ports can be freely assigned to the multicast flows.

### OBJECT OF THE INVENTION

Thus, it is a broad object of the invention to remedy the shortcomings of the prior art as described here above.

It is another object of the invention to provide a system and a method to prevent any form of packet traffic congestion in a shared-memory switch core, adapted to handle multicast traffic.

It is a further object of the invention to permit that an absolute upper bound on the size of the shared-memory, necessary to achieve this congestion-free mode of operation, be defineable irrespective of any incoming traffic type.

It is still another object of the invention to further reduce the above necessary amount of shared-memory of the switch core, while maintaining a congestion-free operation and without impacting performances, by controlling the filling of the shared-memory and keep data packets flowing up to the egress port adapter buffers.

The accomplishment of these and other related objects is achieved by a method for switching unicast or multicast data packets in a shared-memory switch core, from a plurality of ingress port adapters to a plurality of egress port adapters, each of said ingress port adapters including an ingress buffer comprising at least one virtual output queue per egress port to hold incoming unicast data packets and one virtual output queue to hold incoming multicast data packets, each of said ingress port adapters being adapted to send a transmission request when a data packet is received, to store said data packet, and to send a data packet referenced by a virtual output queue when an acknowledgment corresponding to said virtual output queue is received, said method comprising the step of,
updating, in said switch core, a collapsed virtual output queuing array characterizing the filling of each of said virtual output queues upon reception of transmission requests;
selecting a set of one virtual output queue per ingress port adapter holding at least one data packet on the basis of said collapsed virtual output queuing array;
updating said collapsed virtual output queuing array according to said virtual output queue selection;
transmitting an acknowledgment to said selected virtual output queues;
forwarding received data packets to relevant egress port adapters upon reception of said data packets in said shared-memory switch core.

Further advantages of the present invention will become apparent to the ones skilled in the art upon examination of the drawings and detailed description. It is intended that any additional advantages be incorporated herein.

### BRIEF DESCRIPTION OF THE DRAWINGS

FIG. 1 shows a shared-memory switch core of the prior art, equipped with port OQ's whose filling is monitored so as incoming packets can be held in VOQ's to prevent output congestion to occur.

FIG. 2 illustrates the new principle of operation according to the invention.

FIG. 3 further discusses the operation of a switch according to the invention.

FIG. 4 briefly described how requests and acknowledgments necessary to operate a switch fabric according to the invention are exchanged between adapters and switch core.

FIG. 5 discusses the egress part of each port adapter.

FIG. 6 shows how multicast packets are handled in switch core after a multicast acknowledge has been received by ingress adapter, allowing it to send out to switch core the multicast packet waiting at the head of the multicast queue.

FIG. 7 discusses the interactions between requests, acknowledgments and egress tokens which allow to limit the required amount of shared memory of the switch core and egress buffer while allowing a loss-less work-conserving flow of packets to be switched by a fabric according to the invention.

FIGS. 8 and 9 describe the steps of the method to switch and forward unicast and multicast packets in a switch fabric according to the invention, respectively.

FIG. 10 considers an alternate embodiment of cVOQ array of counters.

### DETAILED DESCRIPTION OF THE PREFERRED EMBODIMENT

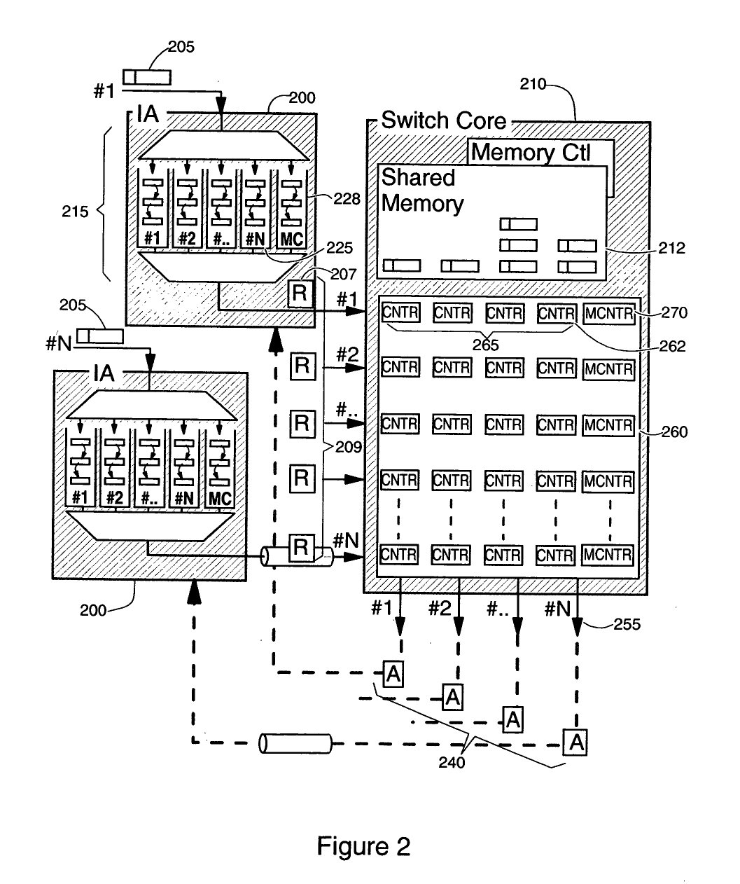

FIG. 2 illustrates the new principle of multicast operation according to the invention.

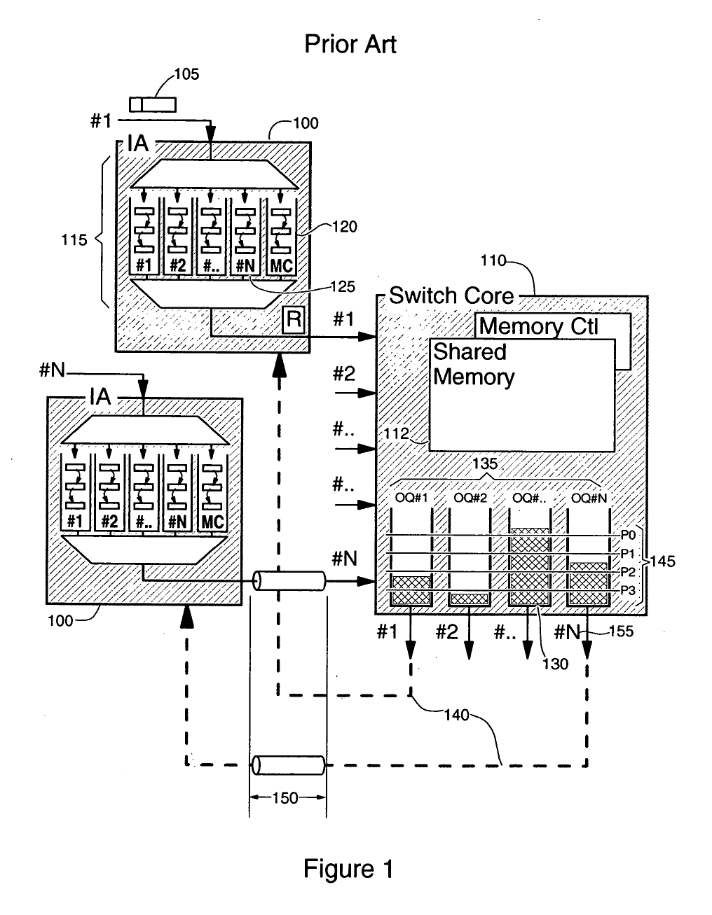

Instead of relying on a feedback from switch core (210) to stop forwarding traffic in case of congestion, thus carrying out a backpressure mechanism as discussed in the background section with FIG. 1, the invention assumes that for each received packet (205), in every IA (200), a request (207) is immediately forwarded to the switch core. As in prior art, the just received packet is queued at the tail of the input queue to which it belongs e.g., the Nth queue(225). Input queues are still organized to form a VOQ (215) per destination and, in general, per class of service (CoS) or flow-ID. As already briefly discussed in the background section, the type of packet-switch considered by the invention assumes that each received packet belongs to a flow allowing to implement a CoS scheme. In the same way HoL blocking may occur because a destination is busy (if packets were not queued by destination), a low priority packet must not stay on the way of a higher priority packet for a same destination. Hence, to avoid priority blocking, VOQ's are most often organized by priority too. That is, there are as many input queues in a VOQ like (215) as there are destinations and priorities to be handled. As an example, a 64 port switch supporting 8 classes of traffic has 64×8=512 queues in each VOQ of IA's (200). More queues may exist if there are other criterions to consider. This is especially the case of the multicast (MC) traffic, i.e., traffic for multiple destinations that generally deserve to have dedicated queues too (also organized by priority). Also, in each IA (200) there is at least, on top of the unicast (UC) queues, one queue (228) for the incoming packets (205) that must be multicast. Head of line (HoL) blocking, for multicast traffic (MC), cannot be generally avoided due to the multiplicity of possible combinations of MC flows as discussed in the background section. Thus, the following description of the invention assumes there is only one MC queue shared by all MC flows. Those skilled in the art will recognize that the scheme of the invention does not preclude the use of more than one queue in an attempt to prevent head of line blocking. However, it is a well established result that having a few MC queues does not really help much unless to have as many queues as MC flows. This is in practice, in most applications, impossible to implement thus, one ingress queue is generally used. On this, one may for example refers to following paper: ‘Tiny Tera: A Packet Switch Core’, by Nick McKeown et al., IEEE Micro, January/February 1997, pages 26-33.

Although, for a sake of clarity, FIG. 2 does not show it, IA's queuing is also generally organized by ‘class of service’ or CoS. That is, for each destination (225), there is a queuing per priority or CoS too. Then, it must be clearly understood that, even though MC queue (228) would be unique for all MC flows, it is still possibly further organized per priority so as to avoid priority HoL blocking like with all the other UC queues. The following description of the invention thus assumes that switch fabric supports a certain number of priorities even though this may not explicitly shown in the figures used to support the description.

Therefore, sending a unicast or multicast request (207) to switch core for each unicast or multicast arriving packet allows to keep track of the state of all VOQ's within a switch fabric. This is done e.g., under the form of an array of counters (260). Each individual counter (262) is the counterpart of an IA queue like (225). On reception by switch core of a unicast or multicast request, that carries the reference of the queue to which it belongs in IA (200), the corresponding counter (262) is incremented so as to record how many packets are currently waiting to be switched. This process occurs simultaneously, at each packet cycle, from all IA's (200) that have received a packet (205). There is thus possibly up to one request per input port at every packet cycle to be processed. As a consequence of above, the array of counters (260) collapses the information of all VOQ's i.e., from all IA's, in a single place. Hence, switch core gains a complete view of the incoming traffic to the switch fabric.

Collapsing all VOQ's in switch core, that is implementing a collapsed virtual output queuing array (cVOQ), allows to return unicast or multicast acknowledgments (240) to all IA's that have at least one non-empty queue. On reception of a unicast or multicast acknowledgment, IA's may unconditionally forward the corresponding waiting unicast or multicast packets e.g., to a shared memory (212) as in previous art from where they will exit the switch core through one (UC flows) or more (MC flows) output ports to an egress adapter (not shown). Issuing acknowledgments from switch core, eventually triggering the sending of a packet from an IA, allow to decrement the corresponding counter so as to keep IA's VOQ and collapsed switch core VOQ, in synch. Hence, because all information is now available in a single place, the collapsed VOQ's in the switch core referred to as cVOQ in the following description, a comprehensive choice can be exercised on what is best to return to IA's at each packet cycle to prevent switch core to become congested and shared memory to overflow thus, maintaining in ingress queues the packets that cannot be scheduled to be switched.

According to what has just been exposed, each MC packet (205), while being queued in IA, triggers the sending of a MC request to the switch core. MC requests simply carry a flag allowing the switch core (210) to distinguish between a unicast request and a multicast one. Like UC requests, which are used to increment counters (265) per destination and are related to one IA, MC requests are used to increment a specific multicast counter (270) per IA. Thus, within the switch core, there are as many MC counters (270) as there are Ingress Adapters (200). Similarly to unicast counters, MC counters collapse the MC queues of all IA's allowing the switch core to get a global view of all multicast requests (UC+MC).

This mode of operation is to compare with the flow control of the previous art (FIG. 1) where each IA is acting independently of all the others. In this case, a choice of the next best packet to forward can only be performed on the basis of the local waiting packets resulting in the forwarding to switch core of packets that cannot actually be switched because there are priority flows, from the other IA's, to be handled first. Although the backpressure mechanism of the previous art eventually manages to stop sending traffic that cannot be forwarded by the switch core, the reaction time in terabit-class switches is becoming much too high, when expressed in packet-times, to be effective e.g., to keep the amount of necessary shared memory to a level compatible with what can be integrated in a chip. On the contrary, the new mode of operation assumes that requests are sent, instead of real packets, on which the switch core is acting first to decide what it can actually process at any given instant.

It is worth noting here that the invention rests on the assumption that an unrestricted amount of requests (in lieu of real packets) can be forwarded to the switch core thus, without necessitating a backpressure on the requests. This is indeed feasible since counters are used for requests instead of real memory to store packets. Doubling the size of a counter requires only one more bit to be added while this requires to double the size of the memory if packets were admitted in switch core as it is the case with a backpressure mode of operation. Hence, because hardware resources needed to implement the new mode of operation grows only as the logarithm of the number of requests to handle, this is indeed feasible. On a practical point of view, each cVOQ individual counter should be large enough to count the total number of packets that can be admitted in an ingress adapter. This takes care of the worst case where all waiting packets belongs to a single queue. Typically, ingress adapters are designed to hold each a few thousand packets. For example, 12-bit (4 k) counters may be needed in this case. There are other considerations to limit the size of the counters like the maximum number of packets to be admitted in IA's for a same destination.

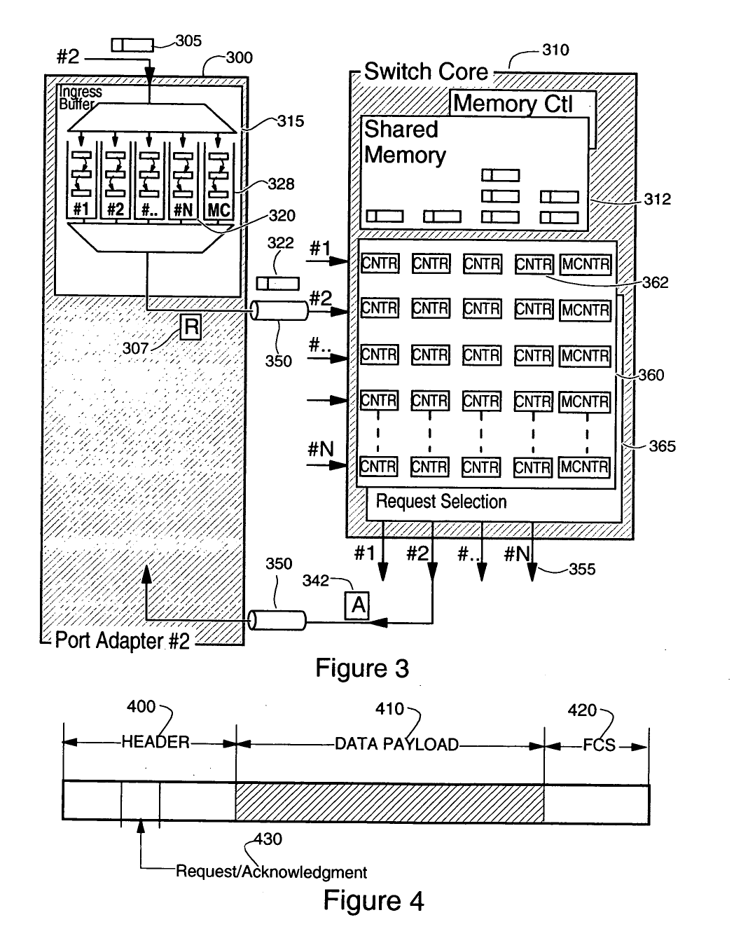

FIG. 3 further discusses the operation of a switch according to the invention. For each packet (305) arriving through the input line of a port adapter e.g., the one tied to switch core (310) port #2 (300), it is stored in an ingress buffer (315) and appended to the tail of the queue it belongs to e.g., queue (320) if packet is destined for the Nth output port, or queue (328) if it is a multicast one, so as it can later be retrieved from buffer and processed in the right order of arrival. Indeed, each queue is a linked list of pointers to the buffer locations where packets are temporarily stored. Techniques for forming queues and attributing and releasing packet buffers from a memory are well known from the art and are not otherwise discussed. The invention does not assume any particular scheme to store, retrieve and form the queues of packets.

Immediately upon arrival of packet, a request (307) is issued to switch core (310). Request needs to travel through cable (350) and/or wiring on the electronic board(s) and backplane(s) used to implement the switching function. Adapter port to switch core link may also use one or more optical fibers in which case there may have also opto-electronic components on the way. Request eventually reaches the switch core so as this later is informed that one more packet is waiting in IA. In a preferred mode of implementation of the invention this results in the increment of a binary counter associated to the corresponding queue i.e., individual counter (362) part of the set of counters (360) that collapse all VOQ's of all ingress adapters as described in previous figure.

Then, the invention assumes there is a mechanism in switch core (365) which selects which ones of pending requests should be acknowledged. No particular selection mechanism is assumed by the invention for determining which IA queues should be acknowledged first. This is highly dependent on a particular application and expected behavior of the switching function. Whichever algorithm is however used only one acknowledgment per output port, such as (342), can possibly be sent back to its respective IA at each packet cycle. Thus, algorithm should tend to always select one pending request per EA (if any is indeed pending for that output i.e., if at least one counter is different from zero) in cVOQ array (360) in order not to waste the bandwidth available for the sending of acknowledgments to the IA's. When several adapters have waiting packets for the same output—there are several non-zero counters in the column corresponding to one egress port (355)—it is always possible to exercise, in a column, the best choice e.g., to select the adapter which has the highest priority packet waiting to be switched. This must be compared to the backpressure mode of operation of the previous art, described in FIG. 1, in which all individual IA's are authorized to push packets in the switch core irrespective of what is present in the other adapters.

Acknowledgments, such as (342), are thus for a given output port in the case of a unicast packet, or for any output port in the case of a multicast packet. More generally, they are defined on a per flow basis as discussed earlier. As a consequence, an IA receiving such an acknowledgment unambiguously knows which one of the packets waiting in the buffer (315) should be forwarded to switch core. It is the one situated at head of line of the queue referenced by the acknowledgment, whatever is the type of traffic, unicast or multicast. The corresponding packet is thus retrieved in buffer and immediately forwarded (322). Because the switch core request selection process has a full view of all pending requests and also knows what resources remain available in the switch core no acknowledgment is sent back to an IA if the corresponding resources are exhausted. This translates, in a shared memory such as (312), by the fact that there must have enough room left before authorizing the forwarding of a corresponding acknowledgment. Also, in such a mode of operation, there is no need to bring into the switch core too many packets for a same output port. There must just have enough packets for every output port so that the switch is said to be work-conserving. In other words a maximum of RTT packets, per output, should be brought in shared-memory if the corresponding input traffic indeed permits it. This is sufficient to guarantee that packets can continuously flow out of any port so that no cycle is ever wasted (while one or more packets would be unnecessarily waiting to be processed in ingress adapter). Having RTT packets to be processed by each core output port leave enough time to send back an acknowledgment and receive a new packet on time. If, as in example of the background section, RTT is 16 packet-times and switch core has 64 ports the shared memory (312) needs to be able to hold a maximum of 64×16=1024 packets. Indeed, if no adapter is located more than 16 packet-times apart from switch core shared memory cannot overflow and a continuous flow of packets can always be sustained to a port receiving 100% of aggregate traffic from a single input port or in any mix of 1 to 64 ports in this example.

A consequence of the mode of operation according to the invention is that it takes always two RTTs to switch a packet (i.e.: 2×16×8=256 ns with 8-ns packets) because a request is first sent and actual packet only forwarded upon reception of an acknowledgment. Hence, this allows to control exactly the resources needed for implementing a switch core irrespective of any traffic scenario. As shown in here above example the size of the shared memory is bounded by the back and forth travel time (RTT) between adapters and switch core and by the number of ports.

No packet is ever admitted in switch core unless it is guaranteed to be processed in RTT time.

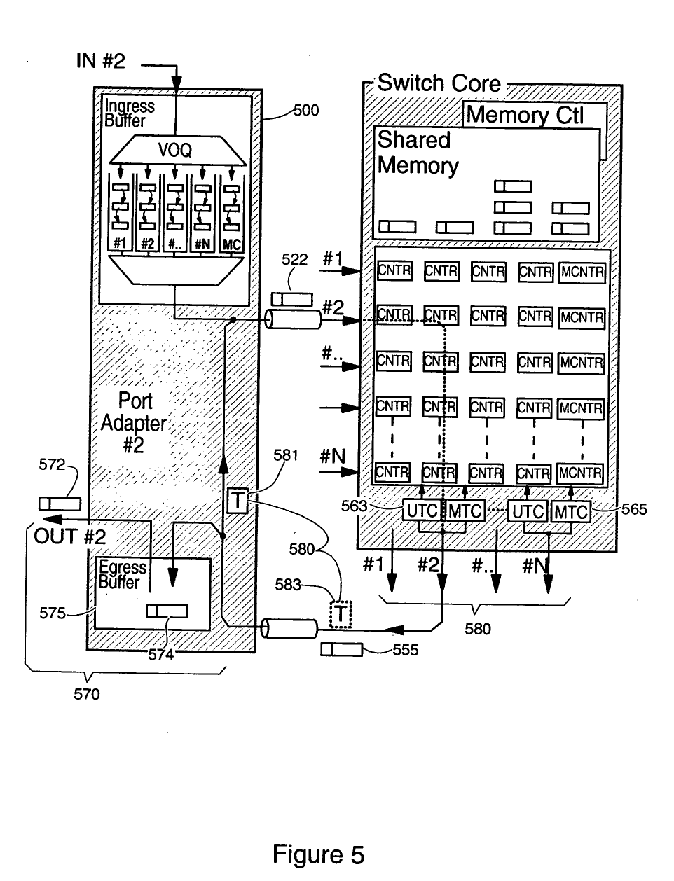

FIG. 4 briefly described how requests and acknowledgments necessary to operate a switch fabric according to the invention and discussed in previous FIGS. 2 and 3 are exchanged between adapters and switch core.

Although many alternate ways are possible, including to have dedicated links and I/O's to this end, a preferred mode of implementation is to have the requests and acknowledgments carried in the header of the packets that are continuously exchanged between adapters and switch core (i.e., in-band). Indeed, in a switch fabric of the kind considered by the invention numerous high speed (multi-Gbps) links must be used to implement the port interfaces. Even though there is no traffic through a port at a given instant, to keep links in synch and running, idle packets are exchanged instead when there is no data to forward or to receive. Whichever packets are ‘true’ packets i.e., carrying user data, or are idle packets, they are comprised of a header field (400) and a payload field (410) this later being significant, as data, in the user packet only. There is also, optionally, a trailing field (420) to check the packet after switching. This takes the form of a FCS (Field Check Sequence) generally implementing some sort of CRC (Cyclic Redundancy Checking) for checking packet content. Obviously idle packets are discarded in the destination device after the header information they carry is extracted.

Hence, there is a continuous flow of packets in both directions, idle or user packets, on all ports between adapters and switch core. Their headers can thus carry the requests and acknowledgments in a header sub-field e.g.: (430). Packets entering the switch core thus carry the requests from IA's while those leaving the switch core carry the acknowledgments back to IA's.

Packet header contains all the necessary information to process the current packet by the destination device (switch core or egress adapter discussed in next figure). Typically, this includes the destination port and the priority or CoS associated to the current packet and generally much more e.g., the fact that packet is a unicast or a multicast packet.

On the contrary of the rest of the header the Request/Acknowledgment sub-field (430) is foreign to the current packet and refers to a packet waiting in ingress adapter. Therefore, Request/Acknowledgment sub-field must unambiguously reference the queue concerned by the request or acknowledgment such as (320) in FIG. 3.

However, regarding MC requests, it must be highlighted that they do not carry any information related to the destinations of the MC packets they have been issued for, other than the fact that their corresponding packet is destined for multiple egress ports. In the same way as unicast and multicast requests are differentiated with a simple flag, acknowledgments such as (240) in FIG. 2, provided by switch core to IAs, are recognized with a similar flag which allows each IA, on reception of either an unicast or a multicast acknowledgment, to know from which VOQ one packet should be taken from and sent to the switch core. This is either the queue referenced by the unicast acknowledgment, or the MC VOQ where MC packets are all waiting until a MC acknowledgment is received.

As an example a packet destined for port N may carry a request for a packet destined for port #2. Thus, carrying packet can be any user packet or just an idle packet that will be discarded by the destination device after the information it carries has been extracted.

It is worth noting here that idle packets can optionally carry information not only in their headers but as well in the payload field (410) since they are not actually transporting any user data.

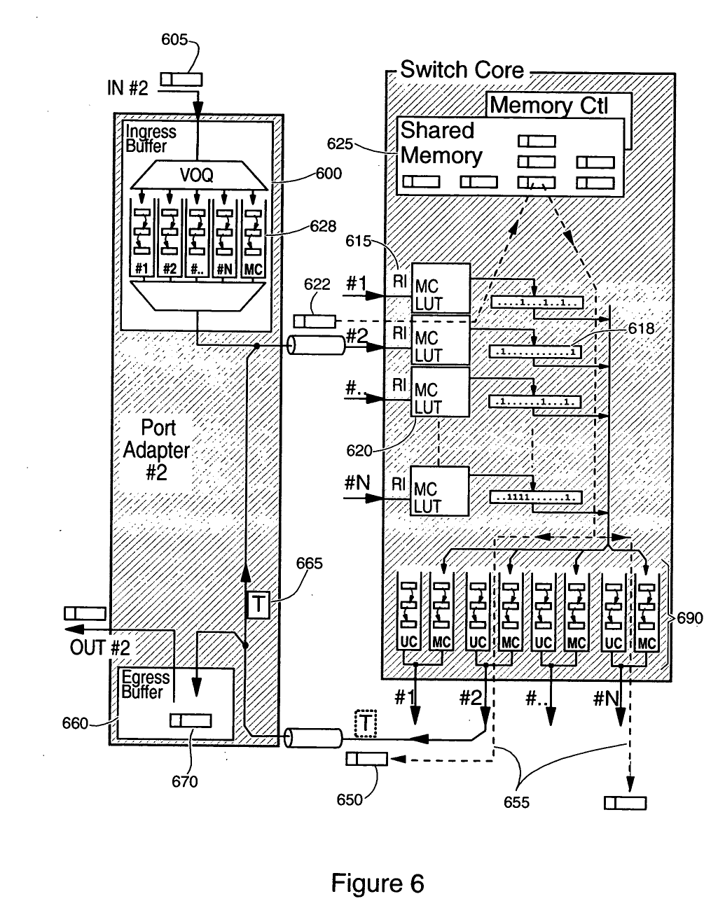

FIG. 5 discusses the egress part (570) of each port adapter (500) e.g., port adapter #2.

The invention assumes there is an egress buffer (575) in each egress adapter to temporarily hold (574) the packets to be transmitted. Egress buffer is a limited resource and its occupation must be controlled. The invention assumes that this is achieved by circulating tokens (580) between each egress adapter (570) and the corresponding switch core port. There is one token for each packet buffer space in the egress adapter. Hence, a token is released to switch core (581) each time a packet leaves an egress adapter (572) while one is consumed by switch core (583) each time it forwards a packet (555). In practice, tokens to the egress buffer (583), take the form of a counter in each egress port of the switch core (563). Counter is decremented each time a packet is forwarded. Thus, in this direction, packet is also implicitly the token and has not to be otherwise materialized.

When a packet is released from egress buffer though, corresponding token counter (UTC) such as (563) for unicast packets or (MTC) such as (565) for multicast packets, must be incremented since one buffer has been freed. In this case tokens like (581) materialize by updating a sub-field in the header of any packet entering switch through ingress port #2. Like with the Request/Acknowledgment sub-field shown in FIG. 4, in a preferred mode of implementation of the invention, there is also a sub-field (not explicitly shown in FIG. 4 though) dedicated to egress tokens in the header of each packet entering the switch core (522) so as the information can be extracted to increment the relevant TC's (563 and 565).

Therefore, switch core is always informed, at any given instant, in each egress port, of how many packet buffers are for sure unoccupied in the egress buffer adapters. Thus, at each packet cycle, it is possible to make a decision to forward, or not, a packet from switch core to egress adapter on the basis of the TC values. Clearly, if a token counter is greater than zero a packet can be forwarded since there is at least one buffer space left in that egress buffer (575).

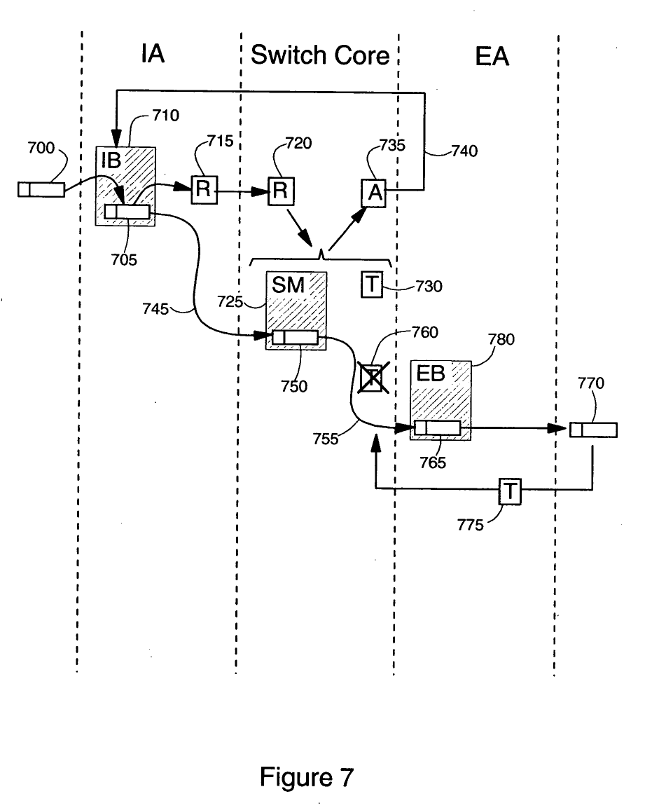

However, in a preferred embodiment of the invention, requests for multicast traffic are assumed to carry only a multicast flag which does not allow to determine alone what is the particular combination of destinations the corresponding packet is destined for (as described in FIG. 6, only packets will carry this information). Indeed, a multicast packet may have potentially to be replicated through any combination of output ports (580). Hence, a multicast acknowledgment should be returned only if all egress adapters have the capability to receive the corresponding multicast packet. In other words, a multicast acknowledgment is only returned if all MT counters (565), which count the number of multicast tokens available in each egress adapter, are positive. This requirement does not bring more restriction and does not add more HoL blocking than the one natively observed with multicast distribution, as long as a limited set of multicast queues is available in IA's.

As already observed with the requests, acknowledgments and packets, up to RTT tokens can be in fly mainly because of the delay of propagation over cables and wiring and because of the internal processing time of the electronic boards. Hence, egress buffer must be able to hold RTT packets so as switch core can forward RTT packets thus, consuming all its tokens for a destination, before seeing the first token (581) returned just in time to keep sending packets to that destination if there is indeed a continuous traffic of packets to be forwarded.

FIG. 6 shows how multicast packets are handled in switch core after a multicast acknowledgment has been received by an IA, allowing it to forward to switch core the multicast packet (622) waiting at head of multicast queue (628). In its header field, each multicast packet carries a routing index (RI) field (615). RI is the usual method of identifying a flow in a switch fabric. If, for example, a 16-bit field is carried in the request, 2¹⁶-1 flows (UC+MC) can be supported which is generally enough for most applications. For each incoming multicast packet, a MC lookup table (620), also referred to as MC LUT, is thus interrogated so as to return a bit map (bm) vector (618) for the corresponding RI. Binary vector has 1's set in positions corresponding to the outputs e.g., the output 2 and N (655), through which a packet must be replicated. Those skilled in the art will recognize that one single MC LUT (620) could be shared by all switch core input ports since the same information i.e., the correspondence between a RI (615) and a bm vector (618), is generally adopted for a whole switching function. However, in the general case, nothing prevents from having a different set of combinations for each input of the switch core. Also, one LUT per input, or shared between a few inputs, may be necessary to be able to meet the high level of performance required by the type of switch considered by the invention.

Simultaneously, while getting a bm vector from LUT, incoming MC packet (622) is temporarily stored in shared memory (625). Depending on a particular implementation this may be for as low as one packet-cycle especially, if all MC tokens are available to replicate and forward the incoming packet to the egress adapters (655) and if no other packets, UC or MC, are waiting to be processed.

Many cases can be encountered depending on the combinations of bm vectors resulting of LUT's interrogations. The simplest case is when EB's targeted by all bm vectors (thus, obtained from LUT's read-outs addressed by RI fields of possibly several simultaneously incoming MC packets arriving from different IA's) do not overlap, moreover, do not overlap either with destinations targeted by unicast packets, which may arrive in the same packet cycle, as a result of unicast acknowledgments that have been sent back by the Request Selection mechanism (365), together with the possible multiple MC acknowledgments. In which case there is no contention at all between packets (unicast or multicast copies) for a same output. However, the general case is when unicast packets and multicast packets, possibly from different sources, contend for a same destination. Nothing is assumed by the invention about the request selection mechanism which may send multiple MC acknowledgments to different IA's as long as there are enough MC tokens available and enough buffer space in shared memory. The worst case is thus when one or more unicast packets, plus as many multicast packets, received from different IA's, as there were MC acknowledgments returned simultaneously to IA's and which now contend for the same switch core egress port. Knowing that only one can be sent per packet-cycle, contending packets need to be temporarily stored in the shared memory (625) for as many cycles as there are packets received for a same egress port in a same cycle.

It is not a purpose of the invention however to choose which packet should be sent out first. Criterions such as packet type (unicast or multicast) or packet priority (high or low) may be used to determine the first packet to be sent to the egress adapter. If unicast packet is sent first, then contending MC packets need to be queued until after the next UC packet departure time. In a preferred embodiment of the invention, this is performed by queuing pointers (690) referencing the shared memory locations of the single copy of those MC packets.

At this point, it should be reminded that one major advantage of shared memory is to natively support multicast. It can indeed deliver as many copies as required from a same packet which needs to be kept in memory until the last copy has been withdrawn, at which time the corresponding buffer space may be released. If unicast packet is not sent first, then it will have to be queued (690), in a way similar to what is to be done when several unicast packets are received in switch core for a same egress port since it is assumed by the invention that the Request Selection mechanism has actually the freedom to do so.

Also, it should also be noticed that the MC token Counters MTC (565) are decremented by one for each MC packet (650) leaving the switch core towards the egress adapter. This indicates that there is one less free position in egress adapter. They are incremented when a multicast token (665) is returned from adapter after one multicast packet has left the adapter egress buffer, thus allowing the switch core to know that one multicast packet location (670) is available again in adapter egress buffer.

It should be mentioned that the differentiation between unicast and multicast tokens, and so the distinction between UTC and MTC counters, usually does not make sense when egress part of adapter has a single physical or logical output. However, there are cases where egress adapter external interface (not shown) is made of several physical or logical outputs. An example can be an adapter connected to a single switch core port providing the equivalent of a 10-Gbps throughput, while actually supporting several external attachments e.g., 4 OC-48 attachments, each one with a 2.5 Gbps throughput. In such a case, an incoming packet may have to be further multicast through several distinct external attachments. Thus, the token (665) corresponding to buffer occupancy of such multicast packet are only returned to switch core when all copies have been forwarded, and memory space released in egress buffer (670).

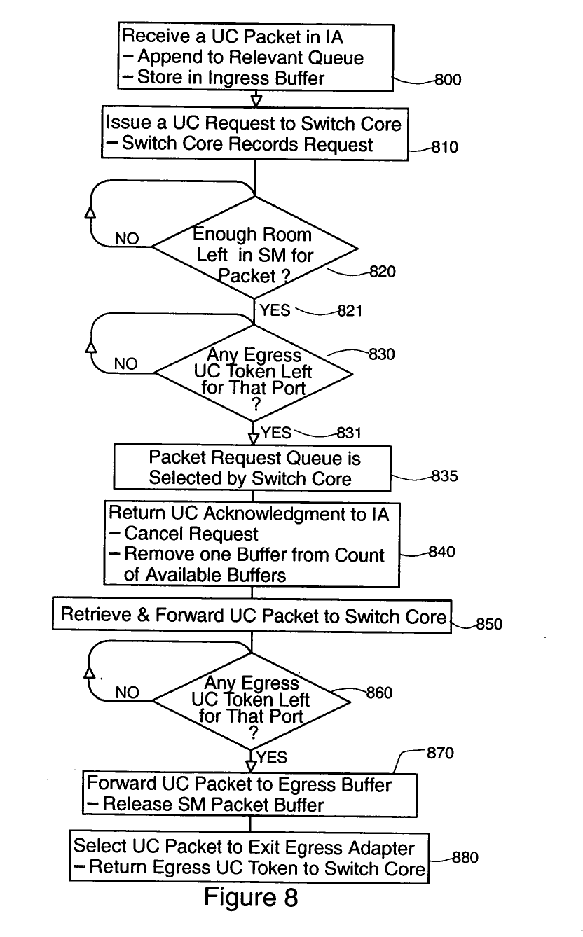

FIG. 7 discusses the interactions between requests, acknowledgments and egress tokens which allow to drastically limit the required amount of shared memory of the switch core and egress buffer while allowing a loss-less work-conserving flow of packets to be switched by a fabric according to the invention without having to make any assumption on traffic characteristics. In other words, contrary to switch fabrics implementing a back-pressure flow-control mechanism, no hot spot or congestion can possibly be observed in a switch core according to the invention since resources, adapted to a given number of ports and for a given RTT, can never be over subscribed. Obviously, traffic that cannot be admitted in switch core accumulates in the corresponding ingress adapters where an appropriate flow-control to the actual source of traffic must be eventually exercised. Overall process of a packet in a switch according to the invention is as follows.

A packet received in an ingress adapter (700) is unconditionally stored (705) in ingress buffer (710) (an upward flow-control to the actual source of traffic is assumed to not overfill the ingress buffer). The receiving of a packet immediately triggers the sending of a request (715). Request travels up to switch core (720) where filling of shared memory (725) and the availability of a token (730), for the egress port to which received packet is destined for, is checked. If both conditions are met i.e., if there is enough space available in shared memory and if there is one or more tokens left then, an acknowledgment (735) may be issued back to IA (740).

Upon reception of the acknowledgment IA forward unconditionally a packet (745) corresponding to the just received acknowledgment. It is important here to notice that there is no strict relationship between a given request, an acknowledgment and the packet which is forwarded. As explained earlier incoming packets are always queued per destination (VOQ), and also generally per CoS or flow, for which the acknowledgment (735) is issued thus, this is always the head-of-queue packet which is forwarded from IA so as no disordering in the delivery of packets is possibly introduced.

When forwarded packet is received in switch core it is queued to the corresponding egress port and sent to the egress buffer (780), in arrival order, consuming one token (760). If no token is available packet forwarding is momentarily stopped. So is the sending of acknowledgments back to the IA's having traffic for that destination. Already received packets wait in SM but no more are possibly admitted until tokens are returned (775) from the egress adapter as discussed in FIG. 5.

Once in egress buffer (780), the packet is queued for the output and leaves (770) egress adapter in arrival order or according to any policy enforced by the adapter. Generally, adapter is designed to forward high priority packets first. If the invention does not assume any particular algorithm or mechanism to select an outgoing packet, from the set of packets possibly waiting in egress buffer, it definitively assumes that a token is released (775) to the corresponding switch core egress port as soon as packet leaves egress adapter (770) so as token eventually becomes available to allow the moving of more packets first from IA to switch core then, from switch core to egress buffer.

At this point, it must be clear that in a switch core according to the invention, the shared memory size need not to be actually as large as the upper bound calculated in FIG. 3. Shared memory is actually made of the real buffering available in switch core plus the egress tokens (730) that represent memory space readily available in all egress buffers. Since packets are sent immediately to the corresponding egress adapters, as long as there are tokens available, shared memory may not really fills up. The size of the necessary shared memory can thus be further limited depending upon the chosen request selection algorithm discussed in FIG. 3 (365). If the algorithm is such that, at each packet cycle, no more than one packet per destination can be brought in switch core then, memory could be strictly limited to one packet per destination since it is guaranteed that all incoming packets can thus immediately be forwarded (provided at least one token is available in each egress port). This puts however severe constraints on the algorithm that become difficult to carry out especially, in large switches and at the speed considered.

Interestingly enough, this is what the well-known iSLIP algorithm (see earlier reference to iSLIP in the background section), devised for switch cores that use a crossbar, must accomplish. Hence, one possible request selection algorithm is iSLIP which allows to drastically limit the size of the shared memory in a switch fabric according to the invention.

The use of a shared-memory allows however to utilize a more efficient algorithm that tolerates the reception, at each cycle, of several packets for the same egress port (thus, from several ingress adapters) and that can be much more easily carried out at the speeds required by modern terabit-class switch fabrics considered by the invention. Any number between one and RTT packets, the maximum necessary as discussed in FIG. 3 (to stay work-conversing without having to rely on the egress tokens though), can thus be considered for the shared memory size. Whatever number is used the corresponding request selection algorithm must match the choice which is made.

As an example, if selection algorithm retained is able to limit to a maximum of four the number of packets selected at each cycle for a same destination then, shared memory for a 64-port switch needs to hold only 64×4=256 packets. Egress buffer must stick to the RTT rule though. That is, in each egress adapter one must have a 16-packet buffer, possibly per priority, if one needs to support a RTT of 16 packet-times. Ingress buffering size is only dependent of the flow-control between the ingress adapter and its actual source(s) of traffic.

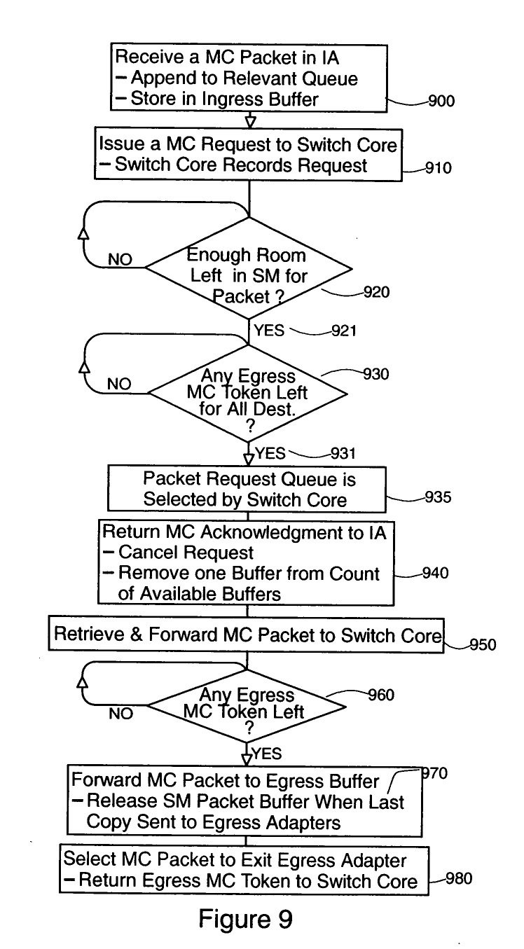

FIGS. 8 and 9 describe the steps of the method to switch and forward unicast and multicast packets in a switch fabric according to the invention. For a sake of clarity, the processes for handling unicast and multicast packets are described independently. Therefore, FIG. 8 focuses on unicast packet while FIG. 9 focuses on multicast packets.

Whenever a unicast data packet is received through the input port to a switch fabric (800) its header is examined. While packet is stored in ingress buffer an entry is made to the tail of the queue it belongs to in order it can later be retrieved. Then, a unicast request, corresponding to the queue it has been appended to, is issued to the switch core (810) which records it in an array of pending requests (cVOQ), image of all the queues of all IA's connected to the switch core and described in FIG. 2. Switch core checks (820) if there is enough room left in its shared memory to receive one more packet for the port addressed by the request and if, at least, one unicast egress token is available (830) for that port. If the answers are positive (821, 831) request can participate to the selection process by switch core within all pending requests in cVOQ array.

When queue to which request belongs is actually selected (835) an unicast acknowledgment (840) is returned to the corresponding IA and request is immediately canceled since it has been honored. Simultaneously, a shared memory buffer space is reserved by removing one buffer from the count of available SM buffers (even though corresponding packet has not been received yet). In a preferred mode of implementation of the invention cancellation of the honored request just consists in decrementing the relevant individual unicast counter in cVOQ array of request counters.

When acknowledgment reaches IA, packet is immediately retrieved and forwarded to switch core (850) where it can be unrestrictedly stored since space has been reserved when acknowledgment was issued to IA. Then, if an egress unicast token is available, which is normally always the case, packet may be forwarded right away to the egress adapter (870) and SM buffer released.

When packet exits the egress adapter, corresponding buffer space becomes free and one egress UC token is returned to switch core (880).

Turning now to FIG. 9, it describes the steps of the method to switch and forward multicast packets in a switch fabric according to the invention.

Whenever a multicast data packet is received through the input port to a switch fabric (900) its header is examined. While packet is stored in ingress buffer an entry is made to the tail of the multicast queue it belongs to in order it can later be retrieved. Then, a multicast request is issued to the switch core (910) which records it in an array of pending requests (cVOQ), image of all the queues of all IA's connected to the switch core and described in FIG. 2. Switch core checks (920) if there is enough room left in its shared memory to receive one more multicast packet and if, at least, one multicast egress token is available for each port (930). If the answers are positive (921, 931) request can participate to the selection process by switch core within all pending unicast and multicast requests in cVOQ array.

When multicast queue to which request belongs is actually selected (935) a multicast acknowledgment (940) is returned to the corresponding IA and corresponding multicast request is immediately canceled since it has been honored. Simultaneously, a shared memory buffer space is reserved by removing one buffer from the count of available SM buffers (even though corresponding packet has not been received yet). In a preferred mode of implementation of the invention cancellation of the honored request just consists in decrementing the relevant individual multicast counter in cVOQ array of request counters.

When acknowledgment reaches IA, packet is immediately retrieved and forwarded to switch core (950) where it can be unrestrictedly stored since space has been reserved when acknowledgment was issued to IA as explained above. Then, if egress multicast tokens are available for all destinations of the multicast packet as indicated by the bitmap obtained through the RI look-up, which is normally always the case, copies of the multicast packet may be forwarded right away to related egress adapters (970) and SM buffer released. In the case where egress multicast tokens would not be immediately available for all destinations, then copies of the multicast packet may be sent only to those ports for which egress multicast tokens are available, while remaining copies will be sent only when egress multicast tokens will be available again, indicating available space in egress adapter. Only when the last copy has been provided, can the SM buffer be released.

When packet exits the egress adapter, corresponding buffer space becomes free and one egress MC token is returned to switch core (980).

A lack of unicast or multicast tokens could result of a malfunction or congestion of egress adapter. Especially, a downward device, to which egress adapter is attached, may not be ready and prevent egress adapter from sending traffic normally (flow control). Another reason for a lack of tokens would be that actual RTT is larger than what has been accounted for in the design of the switch fabric hence, tokens (and requests and acknowledgments) may need more time to circulate through cables and wiring of a particular implementation of one or more ports. In this case switch fabric is under utilized by those ports since wait states are introduced due to a lack of token and because acknowledgments do not return on time.

It must also be pointed out that, because the request selection algorithm of switch core may authorize several acknowledgments for a same egress port be sent back to IA's, or because of reception of MC acknowledgments, several packets are possibly received for a same egress port in a same packet cycle. Obviously, packets stored in SM, must wait in line until they can be forwarded to egress adapter, in subsequent cycles, consuming one egress token each time. Hence, as long as request selection algorithm can manage to send back to IA's one acknowledgment per egress port at each packet cycle, switch core never later receive more than one packet per destination in SM. If tokens are normally available packets are immediately forwarded to egress adapter and stay in SM for one packet cycle only.

Once in egress adapter, packets to forward are selected against any appropriate algorithm depending on the application. Egress tokens are returned to switch core when packets leave the egress buffer (880, 980).

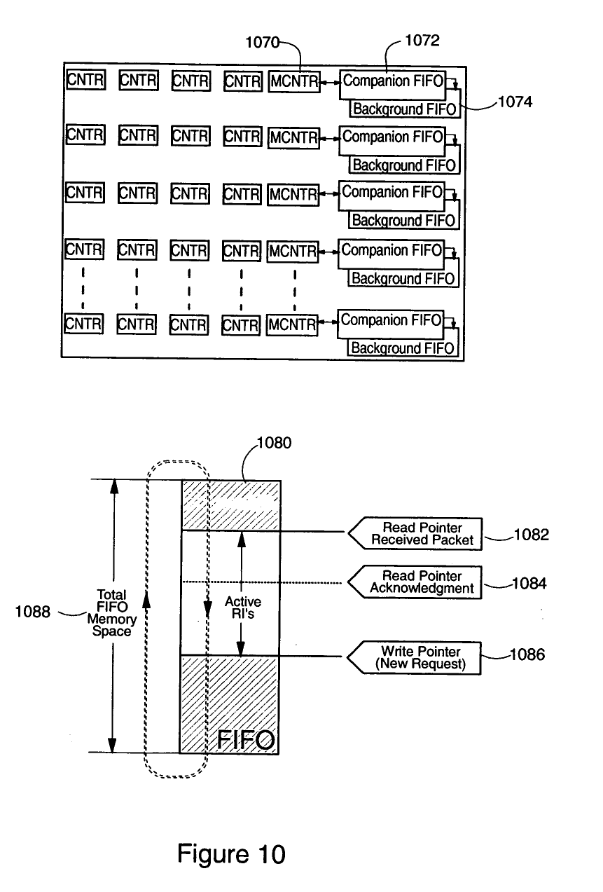

FIG. 10 provides an alternate embodiment of cVOQ array of counters.

Instead of being comprised, as shown in FIG. 2 (270), of a single column of counters that reflect the number of MC packets waiting in ingress adapter MC queues (228) each MC counter (1070) has a companion first-in-first-out FIFO (1072). In this alternate mode of operation RI's, discussed previously, are forwarded with each MC request and queued in FIFO while counter is incremented. Then, when selecting a MC request, it becomes feasible to know which egress ports are concerned by the current head-of-line MC request. For selecting the acknowledgments to return this allows to consider only the ports that will be actually used later to replicate a MC packet. Hence, if a port is blocked, because it malfunctions or it has been flow-controlled by a downward device or for any other reason, this will not prevent selection logic from returning an acknowledgment for all MC requests that do not use it thus, avoiding HoL blocking. As a reminder, to keep switch core logic as simple as possible, here above description of the invention has assumed, up to this point, that, for returning acknowledgments, ALL egress ports must have MC tokens available, even those not concerned by the current MC combination of egress ports.

If, however, a MC request is forwarded from an IA, that needs to be replicated through a blocked port, corresponding MC acknowledgment is NOT going to be returned though and, because there is a single MC queue in IA's the whole MC traffic is going to be stopped anyway. However, this form of HoL blocking can easily be skipped if switch core is indeed informed of the port blocking. Knowing the port is malfunctioning, or after a time-out, it can decide either to ignore this port in the returning of the acknowledgments and later in the replication of the packet from the shared memory, or send a discard command to the corresponding IA so as the packet that cannot be normally multicast is dropped from the IA buffer and cvOQ of switch core updated accordingly so as HoL blocking is removed.

One will also notice that, in this mode of operation where RI's are sent with MC requests, RI may not need to be send again in the MC packet header since information can be saved e.g., in a background FIFO (1074) until packet is received and queued to the output ports. This is done when MC request is selected, companion FIFO (1072) readout and counter (1070) decremented, upon sending an acknowledgment back to corresponding IA. Because packets are always delivered in FIFO order, their header then need only to contain a MC flag so as RI is retrieved from the background FIFO when packet is received in switch core. In practice companion and background FIFO's can be implemented under the form of single FIFO (1080) with two read pointers. One for the request to be acknowledged (1084) and one retrieving the RI of current received packet (1082). There is also a write pointer (1086) to enter a new RI with each arriving MC request. Those skilled in the art of logic design knows how to implement such a FIFO from a fixed read/write memory space (1088) e.g., from an embedded RAM (random access memory) in an ASIC (application specific integrated circuit).

This alternate mode of operation is obviously obtained at the expense of a more complicated switch core but can be justified for applications of the invention where multicasting is predominant like with video-distribution and video-conferencing.

In order to limit the hardware necessary to implement the switch core function of the invention one may want to reduce the size of the counters (and associated FIFO's if any) to what is strictly necessary since many of them have to be used. Typically, a cVOQ array of a 64-port switch, with 8 classes of service, supporting multicast traffic, must implement 64×(64×8+1)=32832 individual counters. Saving on counter size is thus multiplied by this number.

On the contrary of the assumption used up to this point of the description which assumes that an unlimited number of requests (i.e., up to the size of ingress buffers) can be forwarded to switch core, size of cVOQ counters can be made lower than what largest ingress buffer can actually hold. Indeed, they can be limited to count RTT packets provided there is the appropriate logic, in each egress adapter, to prevent the forwarding of too many requests to switch core. In other words, IA's can be adapted so as to forward only up to RTT requests while seeing no acknowledgment coming back from switch core. Obviously, the requests in excess of RTT must be queued in each IA and delivered later when count of packets in corresponding cVOQ counter has, for sure, a value less than RTT thus, can be incremented again. This is the case whenever an acknowledgment is returned from switch core for a given queue. Hence, to limit the hardware required by switch core, a logic mechanism must be added in each IA to retain the request in excess of RTT. This complication in the mode of operation of a switch fabric according to the invention may be justified for practical considerations e.g., in order to limit the overall quantity of logic needed for implementing a core and/or to reduce the power dissipation of the ASIC (application specific integrated circuit) generally used to implement this kind of function.

As a consequence, each individual counter of a cVOQ array can be e.g., a 4-bit counter if RTT is lower than 16 packet-times (so that counter can count in a 0-15 range). Likewise, the size of the companion and background FIFO's can be reduced to RTT instead of, typically, several thousands. Hence, each IA must have the necessary logic to retain the requests in excess of RTT on a per queue basis (thus, per individual counter). Thus, there is e.g., an up/down counter to count the difference between the number of received packets minus the number of returned acknowledgments. If the difference stays below RTT, requests can be immediately forwarded as in preceding description. However, if level is above RTT, sending of one request is contingent to the return of one acknowledgment which is the guarantee that counter can be incremented.

Therefore, in such implementation of the invention counter counting capability is shared between the individual counters of the switch core and the corresponding counters of the IA's.

1. A method for switching unicast or multicast data packets in a shared-memory switch core, from a plurality of ingress port adapters to a plurality of egress port adapters, each of said ingress port adapters including an ingress buffer comprising at least one virtual output queue per egress port to hold incoming unicast data packets and one virtual output queue to hold incoming multicast data packets, each of said ingress port adapters being adapted to send a transmission request when a data packet is received, to store said data packet, and to send a data packet referenced by a virtual output queue when an acknowledgment corresponding to said virtual output queue is received, said method comprising the step of,
updating, in said switch core, a collapsed virtual output queuing array characterizing the filling of each of said virtual output queues upon reception of transmission requests;
selecting a set of one virtual output queue per ingress port adapter holding at least one data packet on the basis of said collapsed virtual output queuing array;
updating said collapsed virtual output queuing array according to said virtual output queue selection;
transmitting an acknowledgment to said selected virtual output queues; and
forwarding received data packets to relevant egress port adapters upon reception of said data packets in said shared-memory switch core.

2. The method of claim 1 wherein a virtual output queue containing at least one multicast data packet can be selected only if said at least one multicast data packet may be temporarily stored in said shared-memory switch core and if all of said egress port adapters can receive said at least one multicast data packet.

3. The method according to either claim 1 or claim 2 wherein said transmission request comprises a flag that indicates if the corresponding data packet is a unicast or a multicast data packet.

4. The method of claim 1 wherein the step of forwarding a received data packet to relevant egress port adapters upon reception of said multicast data packets comprises the steps of,
holding said received data packet;
determining the at least one egress port destination of said data packet;
for each of said at least one determined egress port destination;
evaluating the availability of space; and
if there is available space, transmitting immediately said received data packet to said egress port adapter;
releasing said received data packet when said received data packet is sent to all of said at least one determined egress port destination.

5. The method of claim 4 wherein the space available in an egress port adapter for storing data packet is determined according to a counter associated to said egress port adapter, said counter being decremented when a data packet is forwarded to said egress port adapter and incremented upon reception of a token returned from said egress port adapter for each space becoming available.

6. The method of claim 4 wherein the space available in an egress port adapter for storing unicast data packet is determined according to two counters associated to said egress port adapter, the first one for unicast data packet and the second one for multicast data packet, said first counter being decremented when a unicast data packet is forwarded to said egress port adapter and incremented upon reception of a unicast token returned from said egress port adapter for each space becoming available, and said second counter being decremented when a multicast data packet is forwarded to said egress port adapter and incremented upon reception of a multicast token returned from said egress port adapter for each space becoming available.

7. The method of claim 1 wherein said collapsed virtual output queuing array comprises a plurality of counters, one counter being associated to each of said virtual output queue, the counter value characterizing the number of data packets held in the corresponding virtual output queue.

8. The method of claim 7 wherein the steps of updating said collapsed virtual output queuing array comprises the steps of incrementing by one the counter associated to the virtual output queue from which a request is received and decrementing by one the counters associated to said selected virtual output queues to which an acknowledgment is issued.

9. The method according to claim 1 wherein said transmission requests comprise an indication of the at least one egress port destination of the corresponding data packet.

10. The method according to claim 9 wherein an indication of the egress port destinations of at least one multicast data packet held in said ingress port adapters is stored within said switch core.

11. The method according to claim 10 wherein the switch core memory used to store said indication of the egress port destinations of at least one multicast data packet held in ingress port adapters is limited to the packet round trip time.

12. The method according to claim 9 wherein a virtual output queue containing at least one multicast data packet can be selected only if said at least one multicast data packet may be temporarily stored in said shared-memory switch core and if the egress port destinations of said at least one multicast data packet can receive said at least one multicast data packet.

13. An apparatus comprising:
a switch core having shared memory therein;
a collapsed virtual output queuing array operatively positioned within said switch core;
means to update, in said switch core, the collapsed virtual output queuing array characterizing the filling of each of said virtual output queues upon reception of transmission requests;
means to select a set of one virtual output queue per ingress port adapter holding at least one data packet on the basis of said collapsed virtual output queuing array;
means to update said collapsed virtual output queuing array according to said virtual output queue selection;
means to transmit an acknowledgment to said selected virtual output queues; and
means to forward received data packets to relevant egress port adapters upon reception of said data packets in said shared-memory switch core.

14. The apparatus of claim 13 wherein the shared-memory size is first determined according to the round trip time of the flow control information and the number of ports of said switch core.

15. The apparatus of claim 13 or 19 wherein the shared-memory size is further determined by the choice of an algorithm to select said acknowledgments returned to said ingress port adapters.

16. The apparatus of claim 13 wherein size of said egress buffer is solely determined by the round trip time of the flow control information.

17. A program product comprising computer-like readable medium on which a computer program is recorded, said computer program including instructions for:
updating, in a shared memory switch core, a collapsed virtual output queuing array characterizing filling of each of a plurality of virtual output queues upon reception of transmission requests;
selecting a set of one virtual output queue per ingress port adapter holding at least one data packet on the basis of said collapsed virtual output queuing array;
updating said collapsed virtual output queuing array according to said virtual output queue selection;
transmitting an acknowledgment to said selected virtual output queues; and
forwarding received data packets to relevant egress port adapters upon reception of said data packets in said shared-memory switch core.

18. A method for switching unicast or multicast data packets in a shared-memory switch core comprising:
Providing in said switch core a collapsed virtual output queuing array to track occupancy levels of data in virtual queues storing unicast (UC) and multicast (MC) data packets;
updating, in said switch core, the collapsed virtual output queuing array characterizing the filling of each of said virtual output queues upon reception of transmission requests;
selecting a set of one virtual output queue per ingress port adapter holding at least one data packet on the basis of said collapsed virtual output queuing array;
updating said collapsed virtual output queuing array according to said virtual output queue selection;
transmitting an acknowledgment to said selected virtual output queues; and
forwarding received data packets to relevant egress port adapters upon reception of said data packets in said shared-memory switch core.

19. The apparatus of claim 13 further including at least one ingress port adapter operable coupled to the switch core.

20. The apparatus of claim 19 further including at least one egress port adapter operable coupled to the switch core.

21. The apparatus of claim 13 wherein the collapsed output queuing array includes a first set of counters for handling unicast data packets and a second set of counters for handling multicast data packets.

22. The apparatus of claim 21 wherein the first set of counters includes one counter for each Ingress Virtual Output Queue (IVOQ) and the second set of counters includes one counter for each ingress adapter.
